(19) United States
(12) Patent Application Publication
(10) Pub. No.: US 2023/0001782 A1
(43) Pub. Date: Jan. 5, 2023

(54) AIR FLAP DEVICE FOR A MOTOR VEHICLE INCLUDING AN OPTICAL FUNCTIONAL CHECK

(71) Applicant: Röchling Automotive SE & Co. KG, Mannheim (DE)

(72) Inventors: Mathias Holzheier, Frankfurt (DE); Fabrizio Civetta, Montan (BZ) (IT); Juliane Nies, Kasbach-Ohlenberg (DE)

(21) Appl. No.: 17/854,381

(22) Filed: Jun. 30, 2022

(30) Foreign Application Priority Data
Jul. 5, 2021 (DE) 10 2021 117 280.2

(51) Int. Cl. B60K 11/04; B60K 11/08

(52) U.S. Cl. CPC B60K 11/04; B60K 11/085

(57) ABSTRACT

An air flap device for a motor vehicle, to a plurality of jointly adjustable air flaps and to an actuator for adjusting the plurality of air flaps between a closed position and an open position, the air flap device including a radiative detection device for detecting and assessing a position of the plurality of air flaps; the radiative detection device having a radiation source and a radiation receiver, the radiation source emitting an electromagnetic test radiation in the direction toward the radiation receiver, at least one air flap as a test air flap having a test section through which the test radiation is able to radiate, the test section being situated in the propagation path of the test radiation from the radiation source to the radiation receiver in such a way that only when the test air flap is in a predetermined reference operating position at least a portion of the test radiation radiates through the test section toward the radiation receiver and reaches the radiation receiver with an irradiation result within a predetermined irradiation result space.

This Application claims priority in German Patent Application DE 10 2021 117 280.2 filed on Jul. 5, 2021, which is incorporated by reference herein.

The present invention relates to an air flap device, comprising a frame having an air passage opening, a plurality of air flaps accommodated on the frame in a jointly adjustable manner, which protrude at least into the air passage opening, and an actuator for adjusting the plurality of air flaps between two operating positions of different coverage of the air passage opening by the plurality of air flaps, the air flaps being jointly adjustable between a closed position, in which the air flaps cover the air passage opening to a greater degree against a flow through the passage, and an open position, in which the air flaps cover the air passage opening to a lesser degree against a flow through the passage, the air flap device further including a radiative detection device for detecting and assessing a position of the plurality of air flaps.

### BACKGROUND OF THE INVENTION

Air flap devices on motor vehicles are generally known for allowing a flow of air through the air passage opening and thereby influencing convective cooling of vehicle components situated behind the air passage opening in the direction of flow.

An air flap device of the kind mentioned at the outset having a radiative, in the concrete embodiment optical detection device is known from DE 10 2018 000 955 A1.

To determine whether an air passage opening is correctly covered by a translationally displaceable cover element, two pairs of respectively mutually opposite photo sensors are situated at the air passage opening. The first pair is situated near the gap opening, from which the completely retracted cover element extends. The second pair is situated near an end position, at which in the process of closing the air passage element the longitudinal leading end of the cover element comes to rest in its closed position. In the closed position, the cover element is situated between the two photo sensors of each pair, while in the open position it is situated between none of the photo sensors. Due to the fact that in the closed position of the cover element the photo sensors are situated near the cover element and facing the latter, an adjustment of the cover element between its open position and its closed position changes the amount of light incident on the respective photo sensors. In this manner, an evaluation device coupled to the known radiative detection device is able to ascertain on the basis of the signals of the photo sensors whether the cover element is in an open position, in which it covers no photo sensors, in a closed position, in which it covers the photo sensors of both pairs, or in an intermediate position, in which it covers only the photo sensors of the sensor pair situated closer to the gap opening.

A disadvantage of this arrangement is the requirement that the photo sensors must be situated in the area of the air passage opening. Thus, if the photo sensors are not to reduce the flow-through cross section of the air passage opening, the air passage opening must be enlarged by the area occupied by the photo sensors, for which the required space is not always available.

Furthermore, it is possible to draw the photo sensors sufficiently near the described translationally movable cover element, so that the cover element is able to influence the incidence of light on the photo sensors in its various operating positions with sufficient distinctness. This solution, however, appears to be unsuitable for an arrangement having a cover element that is swivable between its operating positions.

Furthermore, DE 10 2019 119 353 A1 discloses an air flap device having multiple air flaps in parallel to one another, which are arranged on the frame so as to be swivable between their open position and their closed position about likewise parallel swivel axes. The adjusting drive of the air flaps includes a detection formation, which at the end of an adjustment movement is in different adjustment positions depending on whether the air flap device is functioning or not. As shown by DE 10 2019 119 353 A1, the position of the detection formation may also be detected by optical sensors.

A disadvantage of this solution is an elaborate mechanical detection device having interacting cams and cam disks, which in actual fact detects whether the air flaps of the air flap device are in the position corresponding to their respective operating state or not. The end position resulting for the detection formation is merely the consequence of the work of the elaborate mechanical detection device.

### SUMMARY OF THE INVENTION

The object of the present invention is to develop the air flap device mentioned at the outset in such a way that it makes it possible to check the correct functioning of the air flap device reliably and with little expenditure. The objective is a check of the air flap device by the radiative detection device as an on-board diagnosis in a vehicle.

The present invention achieves this object in an air flap device of the kind mentioned at the outset in that the radiative detection device comprises a radiation source and a radiation receiver, the radiation source emitting an electromagnetic test radiation in the direction of the radiation receiver, at least one air flap from the plurality of air flaps as a test air flap having a test section through which the test radiation is able to pass, the test section being situated in the propagation path of the test radiation from the radiation source to the radiation receiver in such a way that when the test air flap is in a predetermined reference operating position, at least a portion of the test radiation radiates through the test section toward the radiation receiver and reaches the radiation receiver with an irradiation result within a predetermined irradiation result space, and when the test air flap is not in the predetermined reference operating position, the test radiation does not reach the radiation receiver with an irradiation result within the predetermined irradiation result space.

Instead of the expression “irradiation result space” the expressions “irradiation result range” or “irradiation sample space” could be used. In the subsequent application text the use of “irradiation result space” is maintained.

First, the use of a radiation source provides a defined test radiation for analyzing the operability or the operating state of the air flap device, which is usable in a more precise manner for the desired analysis than the random radiation used by the four photo sensors of the flap device known from DE 10 2018 000 955 A1. The provision of a defined test radiation by a defined radiation source allows for a more precise analysis of the radiation incident on the radiation receiver with respect to its radiation properties, independently of external radiation conditions. Thus, a result space of possible irradiation results may be defined, which defines irradiation results of an operational and/or correctly functioning air flap device, so that whenever the irradiation result is within the predetermined irradiation result space, the evaluation device is able to infer a correctly working air flap device.

The permanent disposition of a test section in the radiation path of the test radiation from the radiation source toward the radiation receiver also checks the test air flap at all times, so that an influence on the test radiation by causes other than the test section is nearly excluded. In the flap device known from DE 10 2018 000 955 A1, it is possible for example that foliage enters the space between the photo sensors of a pair of radiation receivers and thus bring about an assessment of the operability and/or of the operating state of the flap device that has no connection to the actual operating state.

In principle, the detection device described above for assessing whether the air flap device is functioning correctly may be used on a single test air flap. Preferably, however, the detection device is to make it possible to check the operability or correct functioning of as many air flaps of the air flap device as possible. For this reason, the air flap device preferably has multiple air flaps that are developed as test air flaps. Particularly preferably, all air flaps of the air flap device are developed as test air flaps. It is pointed out expressly that when it is said in the present application that the plurality of air flaps includes multiple test air flaps, each of which includes a test section, it is not excluded that in addition to the plurality of air flaps developed as test air flaps further air flaps are provided, which are not developed as test air flaps having a test section.

The plurality of air flaps mentioned at the outset may be connected by a linkage and/or gearing for the joint adjustment movement, so that advantageously a single actuator may suffice for adjusting the plurality of air flaps.

In the sense of an on-board diagnosis, it is advantageous if it is possible to diagnose a faulty state of a single air flap of the plurality of test air flaps. This may be achieved in that the multiple test air flaps with their test sections are arranged in series, so that the test radiation reaches the radiation receiver with an irradiation result within the predetermined irradiation result space only when all test air flaps of the plurality of air flaps are in their respective reference operating position. Preferably, the test radiation does not reach the radiation receiver with an irradiation result within a predetermined irradiation result space when at least one of the multiple test air flaps is not located in its reference operating position.

The reference operating position is preferably a defined and readily reachable end position of the at least one test air flap.

In principle, the test radiation may be any electromagnetic radiation. The test radiation is preferably light in the visible range. The test radiation, however, may also comprise or be light in the non-visible range such as ultraviolet light or infrared light, for example.

The air flaps preferably protrude not only into the air passage opening in order to change the air flow through it as a function of their operating position, but span the air passage opening. The air flaps are therefore preferably at their two ends adjustably accommodated on the frame, while in between a planar flap section ensures a desired degree of coverage of the air passage opening as a function of the operating position of the air flap. The test air flap therefore preferably has a planar flap section, which is situated in the area of the air passage opening for changing the air flow through it, and which hinders a flow through the air passage opening to different degrees depending on the operating position of the air flap relative to the frame. For supporting the test air flap, the latter preferably has a bearing section which is designed in interaction with a mating bearing section on the frame to support the test air flap in adjustable fashion on the frame.

In the above-described preferred spanning of the air passage opening by the air flap, the bearing section preferably comprises one partial bearing section on each side of the planar flap section, particularly preferably one partial bearing section on each longitudinal end of the test air flap.

In principle, at least one further section of the air flap or test air flap may be located between the bearing section or a partial bearing section and the flap section. To ensure that the detection device does not unnecessarily occupy or cover a portion of the area of the air passage opening, the test section is preferably developed outside of the planar flap section. Since the bearing section normally interacts with a mating bearing section of the frame, the bearing section is normally located outside of the air passage opening, which is why the test section is preferably developed in the bearing section so that the detection device interferes as little as possible or optimally does not interfere at all with the air passage opening.

For this reason, the detection device or its radiation source and radiation receiver are also preferably located on one and the same side of the air passage opening so that the test radiation emitted by the radiation source preferably does not radiate through the air passage opening.

Although the air flaps of the air flap device and in particular the at least one test air flap may be situated on the frame in translationally displaceable fashion, in order to obtain an air flap device that is as compact as possible, it is preferable if the at least one test air flap is situated on the frame so as to be swivable about a flap swivel axis. If this application mentions an axial direction, this is a direction along the flap swivel axis, unless indicated otherwise.

It is then possible for radiation to pass through the test section crosswise with respect to the flap swivel axis, in particular orthogonally to the flap swivel axis, which facilitates the aforementioned series arrangement of multiple test sections in the radiation path of the test radiation from the radiation source to the radiation receiver. Without interfering with the flow through the air passage opening by situating the detection device within it, it is possible, however, for the test radiation to radiate additionally or alternatively through the test section along the flap swivel axis. In this case, the test air flap is preferably designed so that the test radiation is able to radiate through it along its entire extension along the flap swivel axis. It may then be necessary to situate a separate radiation receiver for each test air flap in order to test each individual air flap for its operability and/or for its correct functioning on the basis of the test radiation radiating through it.

In the simplest case, the test section may comprise or be a clearance. The test section may then be a hollow space, in which the test radiation is able to propagate unhindered.

The test section may comprise an optical radiation conductor having an entry area and an exit area so that the test radiation may be radiated through the test section in the most targeted manner possible. The term “optical radiation conductor” is directed to the aforementioned preferred development of the test radiation as light in the visible range. The term “optical radiation conductor”, however, is to be understood as covering any kind of radiation conductor that conducts electromagnetic radiation by total reflection at its boundary surface. A radiation conductor conducting UV or infrared light is thus also an optical radiation conductor in the sense of the present application. The optical radiation conductor situated in the test section conducts the electromagnetic test radiation from an entry area to an exit area of the optical radiation conductor, so that it is possible to input test radiation into the optical radiation conductor in one section of the optical radiation conductor and to extract test radiation from the radiation conductor in another section. The entry area and the exit area are preferably developed at different longitudinal ends of the optical radiation conductor, although this is not necessarily so.

The test section and/or the radiative detection device may comprise at least one beam-refracting and/or beam-diffracting and/or beam-polarizing and/or beam-interfering device in order to modify the test radiation so that the detection is as reliable and error-free as possible.

Likewise, fundamentally, the radiation source as a punctiform light source may emit electromagnetic radiation in a more or less divergent manner, only the portion of the electromagnetic test radiation reaching the at least one test section then being relevant for the further function of the detection device. In that case, however, multiple test sections situated in series one behind the other between the radiation source and the radiation receiver must be situated strictly one behind the other along a radius beam originating from the radiation source. Greater constructive freedom in the arrangement also of multiple test air flaps to be tested may be obtained in that the radiative detection device comprises an optical radiation conductor which conducts the test radiation at least along a section of the path from the radiation source to the radiation receiver. The optical radiation conductor of the detection device preferably conducts the test radiation on its entire path from the radiation source to the radiation receiver, with the exception of those sections, in which the test radiation radiates through the at least one test section of the at least one test air flap. Such an optical radiation conductor of the detection device is preferably fixed on the frame and is therefore immobile relative to the frame of the air flap device.

The frame of the air flap device may be a separate frame, which may also be made up of multiple parts. The frame may be made up entirely or partially by body components of a vehicle supporting the air flap device.

Due to the increased constructive freedom achieved by the optical radiation conductor, this optical radiation conductor is able to run at least once, preferably multiple times in curved fashion about axes of curvature situated at a distance from one another.

The radiation source and the radiation receiver are not only preferably situated on the same side of the air passage opening. To obtain a more spatially compact air flap arrangement, the radiation source and the radiation receiver may also be situated in close spatial proximity on the same side of the at least one test section, preferably of all test sections to be tested by the radiation source and the radiation receiver. The radiative detection device may then comprise a radiation reversal device, which deflects the test radiation reaching it by 170° to 190°, so that it returns to the area of its place of origin, where the radiation receiver may be situated near the radiation source, for example adjacent to it. The radiation reversal device may be a mirror, a prism having reflecting, preferably totally reflecting, boundary surfaces or a reversal loop of a flexible radiation conductor.

For example, the radiation conductor, be it the radiation conductor in the test section or the radiation conductor of the detection device situated outside of the test sections, may comprise a glass fiber or a bundle of glass fibers.

As was already explained above, the test radiation may be able to radiate through the at least one test air flap along the flap swivel axis. When the test section through which the test radiation is able to radiate is situated outside of the flap swivel axis, it is possible to ensure in a simple manner that the test radiation is sufficiently able to radiate through the at least one test air flap only in one operating position, but not in an operating position distinct from this operating position. When the test section is situated centrally with respect to the flap swivel axis and extends along the same, the radiation through the test section is normally independent of the operating position of the test air flap since the location of the introduction of test radiation into the test section does not change by a rotation of the test air flap about the flap swivel axis. In order to be able to assess the operability and/or the correct functioning of the test air flap even in such cases, the radiative detection device may comprise at least one beam-refracting and/or beam-diffracting and/or beam-polarizing and/or beam-interfering device. Preferably, at least one such device is provided fixed on the frame, so that the irradiation of test radiation onto the radiation receiver is able to change as a function of the rotational position of the test air flap about the flap swivel axis and the refraction and/or diffraction and/or interference achieved thereby. The device should therefore refract, diffract, polarize and/or interfere with radiation in a manner that is preferably not rotationally symmetric. Preferably, a device of this kind may be provided on the test section, which produces a refraction and/or diffraction and/or polarization and/or interference that is not rotationally symmetric with respect to the flap swivel axis when the test radiation exits from the test section. The exit patterns in the test radiation produced during the exit from the test section then also differ as a function of the rotational position of the test air flap about the flap swivel axis and may be detected accordingly by the radiation receiver.

It is thus possible, for example, to provide a polarization filter that is fixed on the frame side and a polarization filter that rotates together with the test air flap about the flap swivel axis, so that the polarization filter of the test air flaps rotates in their swivel movement about the flap swivel axis relative to the polarization filter fixed on the frame side. Only when the polarization planes of the two polarization filters are aligned in parallel to each other does sufficient test radiation reach the radiation receiver. Otherwise, the radiation quantity received in the radiation receiver does not suffice to exceed a predetermined intensity threshold as a limit of a possible irradiation result space, which indicates a correct functioning of the test air flap. The same applies instead of polarization filters to diffraction gratings and the like and to refraction elements or interference elements.

For assessing the operability and/or the arrangement in an operating position of the at least one test air flap, the radiation receiver may be designed to differentiate irradiation results in terms of at least one of the following irradiation properties of irradiation intensity, irradiation wave length, irradiation location and irradiation pattern of the test radiation irradiating the radiation receiver. The predetermined irradiation result space may then comprise a predetermined intensity range and/or a predetermined wavelength range and/or a predetermined area of incidence for irradiating test radiation and/or a predetermined range of irradiation patterns, with which an evaluation device comprised by the radiation receiver or coupled to the latter in signal-transmitting fashion is able to compare the detected irradiation result. In this manner, it is also possible to test two different operating positions, preferably end positions of the test air flap, a different predetermined intensity threshold being assigned to each end position, which is to be undershot or to be exceeded, preferably another predetermined intensity range being assigned as an irradiation result space, within which the intensity of the test radiation received in the radiation receiver in the respective operating position must lie in order to pass the test.

The present invention also comprises a motor vehicle, which is equipped with an air flap device developed as described above. The air flap device is preferably located at the front end of the vehicle and has air streaming onto it when the vehicle is driving forward. A control device of the vehicle is preferably developed for signal transmission with the detection device of the air flap device and for evaluating signals transmitted by the detection device.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 a rough schematic top view onto a first specific embodiment in accordance with the invention of an air flap device of the present invention,

FIG. 2 a rough schematic top view onto a diagrammatic sketch of a specific embodiment largely corresponding to the first specific embodiment with air flaps in the closed position,

FIG. 3 the specific embodiment from FIG. 2 as a diagrammatic sketch with open air flaps in the open position,

FIG. 4 a rough schematic diagrammatic sketch of a further specific embodiment of an air flap device of the present invention.

### DESCRIPTION OF PREFERRED EMBODIMENTS

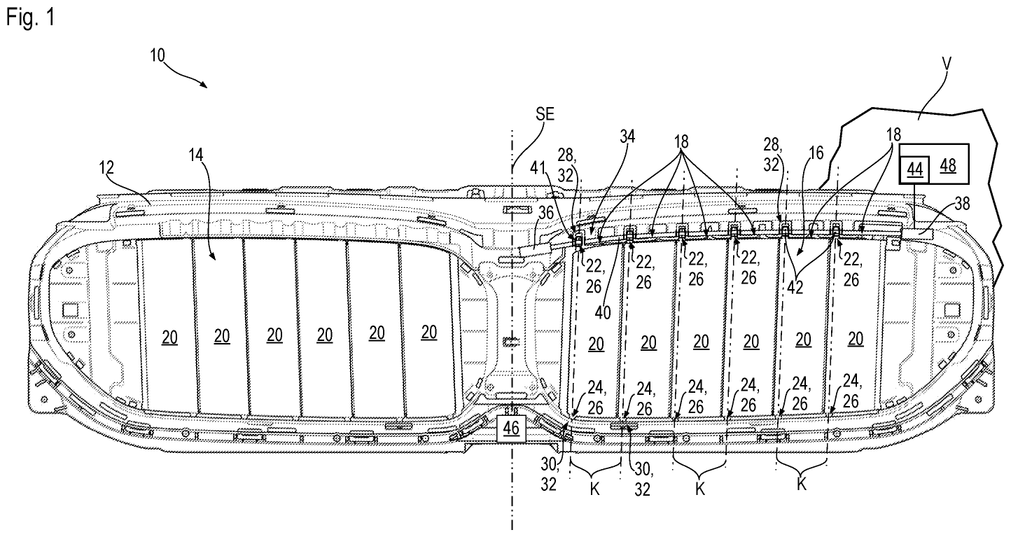

Referring now to the drawings wherein the showings are for the purpose of illustrating preferred and alternative embodiments of the invention only and not for the purpose of limiting the same, in FIG. 1, an air flap device of the present invention according to a first specific embodiment is generally designated by reference numeral 10. The air flap device 10 has a frame 12, in which two air passage openings 14 and 16 are developed for air to flow through orthogonally to the drawing plane of FIG. 1. The air flap device 10 is developed essentially in mirror symmetry with respect to a mirror symmetry plane SE that is orthogonal to the drawing plane of FIG. 1, which is why it suffices to describe only the right half of the air flap device 10 in FIG. 1. The left half of the air flap device 10 corresponds to the right half in its structure under the aforementioned condition of mirror symmetry.

In the illustrated operating state of FIG. 1, the right passage opening 16 is closed by six air flaps 18 swivable about respective flap swivel axes K. In the operating state shown in FIG. 1, the air flaps 18 are in their closed position, in which they allow no or only a negligible air flow through the passage opening 16.

Centrally along the flap swivel axis K, each air flap has a planar flap section 20, from which axially relative to flap swivel axis K on both sides respectively one upper bearing journal 22 and one lower bearing journal 24 protrude as a bearing section 26. The bearing journals 22 and 24 are accommodated in frame-side bushings 28 and 30, respectively, as mating bearing sections 32, so as to be swivable about flap swivel axis K.

For reasons of better clarity, not all bearing journals and bushings are labeled by reference numerals.

For the on-board diagnosis of the correct functioning of the air flap device 10, the air flap device 10 has a radiative, in the present case optical, detection device 34. This comprises a radiation source 36 in the form of a light source and a radiation receiver 38 in the form of a photocell or a CCD field.

The detection device 34 further comprises a radiation conductor 40 fixed on the frame in the form of a light conductor, formed by way of example by a bundle of glass fibers. The radiation conductor 40 runs, interrupted by the upper bearing journals 22, from the radiation source 36 to the radiation receiver 38. The radiation conductor 40 runs parallel to the upper edge of the air passage opening 16 along a curved path. The advantage of using the radiation conductor 40 lies precisely in this possibility of conducting electromagnetic radiation, in this case light, along nearly any path reliably and as loss-free as possible.

A radiation conductor 42, in this case a radiation conductor fixed on the flap, is likewise situated in the upper bearing journal 22 of the air flaps 18, which interrupts the frame-fixed radiation conductor 40, for example by injection molding around the flap-fixed radiation conductor 42 if air flaps 18 are produced by injection molding. The flap-fixed radiation conductor 42 runs in each air flap 18 crosswise to the flap swivel axis K.

The bearing journal 22 equipped with a radiation conductor 40 forms a test section 41, cooperating with the detection device 34, of the air flap 18, which is a test air flap on account of the development of test section 41.

The air flaps 18 may be designed identically or may be designed differently, depending on the location of their arrangement in the air passage opening 16.

The radiation conductors 42 fixed on the flaps may be formed of the same material as the radiation conductors 40 fixed on the frame.

In the illustrated example of FIG. 1, the flap-fixed radiation conductors 42 conduct light from the adjacent section of the frame-fixed radiation conductor 40, located closer to the radiation source 36, to the adjacent section of the frame-fixed radiation conductor 40, located closer to the radiation receiver 38, only when the air flaps 18 are in the closed position shown in FIG. 1.

In the open position, the air flaps 18 are swiveled so far about the flap swivel axis K that each section of the frame-fixed radiation conductor 40 adjacent to the upper bearing journal 22 is opposite to a section of the material of the remaining bearing journal 22 that is opaque or that is at least more diffusive than a radiation conductor and in any event unsuitable for radiation conduction, so that no test radiation is able to enter the flap-fixed radiation conductor 42 from the section of the adjacent frame-fixated radiation conductor 40 located closer to the radiation source 36 and be conducted by the flap-fixed radiation conductor 42 to the adjacent section of the frame-fixed radiation conductor 40 located closer to the radiation receiver 38.

Light, as the test radiation of the present example, therefore reaches the radiation receiver in the intended quantity only when all air flaps 18 are jointly in the closed position. If only one of the air flaps 18 is not in the closed position, light emitted by the radiation source 36 does not reach the radiation receiver 38 with a light intensity within a predetermined setpoint intensity range as a possible irradiation result space. The detection device 34 in cooperation with an evaluation device 44 is therefore able to assess whether all air flaps 16 of the air passage opening 16 are actually in the closed position when they are supposed to be in the closed position due to an operation of an actuator 46 adjusting the air flaps 18 between the closed position and the open position. The evaluation device 44 may be part of a control device 48 of a vehicle V supporting the air flap device 10 or may be connected by signal transmission to a control device 48 of the vehicle V, so that the evaluation device 44 is able to transmit, either its evaluation result or the signals of the radiation receiver 38 transmitted to it, to the control device 48 of the vehicle V.

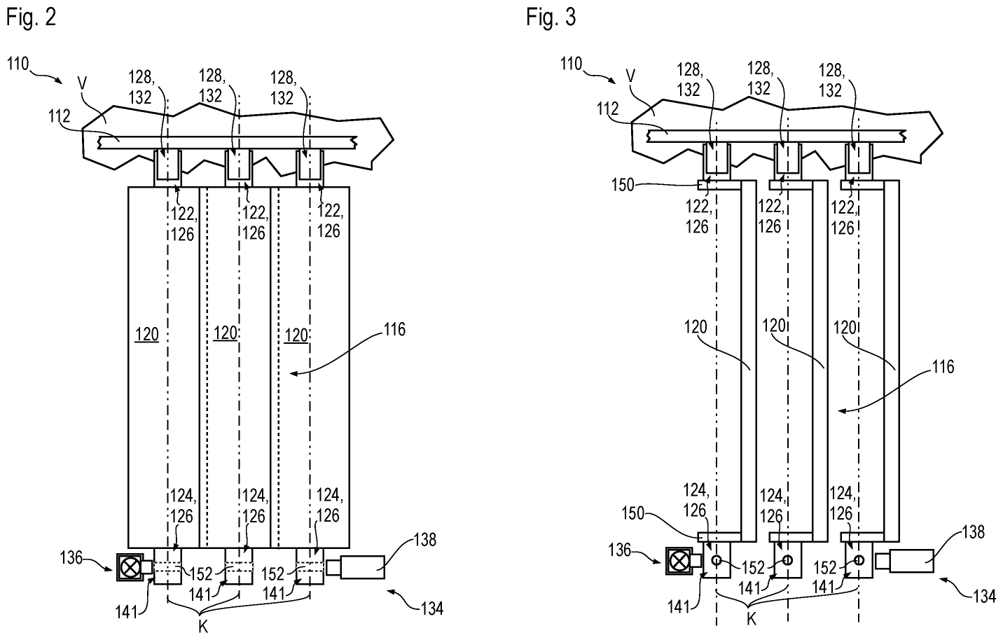

FIGS. 2 and 3 show in rough schematic fashion a specific embodiment, whose functional principle corresponds essentially to that of the specific embodiment from FIG. 1. Identical and functionally identical components and component sections as in FIG. 1 are provided with the same reference symbols in FIGS. 2 and 3, but increased by 100. The specific embodiment of FIGS. 2 and 3 is described in detail below only to the extent that it differs from that of FIG. 1, to the description of which reference is otherwise made also for explaining the specific embodiment of FIGS. 2 and 3.

In FIGS. 2 and 3, at the lower edge of the air passage opening 116, the section of the frame 112 with the mating bearing sections 132 supporting the air flaps 118 is not illustrated for the sake of clarity. At the upper sections of the frame 112 and the mating bearing sections 132 illustrated there, it may be seen that the latter surround the upper bearing journals 122 over a circumferential section as partially cylindrical brackets 128. For each bearing journal 122, preferably two mutually diametrically opposite partially cylindrical brackets 128 are provided, which retain the respective bearing journal 122 between each other. Instead of the partially cylindrical bracket pairs, it is of course possible to use any other kind of mating bearing section that supports the bearing journals 122 with sufficient definition for a swivel movement about the flap swivel axis K. The upper and the lower swivel bearings of the air flaps 118 preferably have an identical design.

As may be seen in FIG. 3 in the open position of the air flap device 110, if the planar flap body 120 is situated outside of the flap swivel axis K, the respective bearing journal 122 and 124, respectively, may be connected to the flap body 120 via a web 150.

Cylindrical clearances 152 are developed in the lower bearing journals 124. These cylindrical clearances 152 are aligned in the closed position shown in FIG. 2. Their cylinder axes are then essentially collinear. In the closed position, therefore, light emitted in a diverging manner by the radiation source 136 is able to reach the radiation receiver via the clearances 152 aligned in series one behind the other in such a way that the irradiation result of the light emitted by the radiation source 136 is within a predetermined irradiation result space, for example within a predetermined intensity range. When the air flap device 110 is supposed to be in the closed position and the radiation receiver 138 transmits to the evaluation device an irradiation result that lies within a predetermined irradiation result space associated with a correct functioning of the air flap device 110, the evaluation device infers an operational and correctly functioning air flap device 110. If, by contrast, the air flap device 110 is in the closed position and the irradiation result lies outside of the predetermined irradiation result space, the evaluation device detects a faulty air flap device 110.

In the aligned arrangement of the clearances 152 of the individual air flaps 118 shown in FIG. 2, it suffices to provide the clearances 152 as hollow spaces. As shown in FIG. 3, in the open position of the air flap device 110, there exists no line of sight from the radiation source 136 to the radiation receiver 138. Rather, the propagation path of radiation emitted by the radiation source 136 toward the radiation receiver 138 is interrupted by the opaque bearing journals 124. Deviating from the exemplary embodiment of FIG. 1, it is also possible that no radiation conductor is situated between the bearing journals 124 and/or between at least one device made up of radiation source 136 and radiation receiver 138 on the one hand and the respectively most proximate bearing journal 124.

Since the air flaps 18 and 118 are coupled for joint movement via a coupling mechanism, such as for example a linkage or gearing, only a portion of the air flaps may be adjusted by the actuator when the coupling mechanism fails for example, while a faulty air flap 18, 118 is no longer moved by the coupling mechanism. The present detection device 34 or 134 is able to detect this situation.

The clearance 152 of at least one air flap 118 may accommodate, as in FIG. 1, a radiation conductor running along the clearance 152. This is advantageous especially when it is not possible to transmit the radiation from the radiation source 136 to the radiation receiver 138 in a straight line.

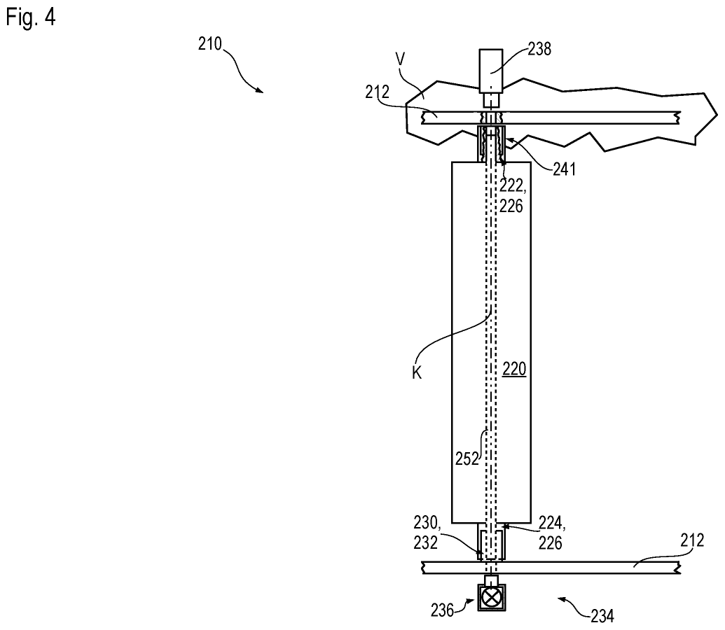

FIG. 4 illustrates a further specific embodiment of the detection device 234 in rough schematic fashion. Components and component sections identical and functionally identical to those in FIGS. 1 to 3 are labeled in FIG. 4 with the same reference numerals, but in the number range from 200 to 299. The specific embodiment of FIG. 4 is described in detail below only to the extent that it differs from those of FIGS. 1 to 3, to the description of which reference is otherwise made also for explaining the specific embodiment of FIG. 4.

FIG. 4 shows an air flap 218, through which test radiation of the radiation source 236 is able to pass, not crosswise with respect to its flap swivel axis K, but rather along the same. In contrast to the previous specific embodiments, a separate radiation receiver 238 is therefore assigned to each air flap 218 developed as a test air flap.

In the illustrated exemplary embodiment, the clearance 252 of air flap 218 extends axially on both sides of the air flap 218 in the frame as upper frame-side clearance 254 and as lower frame-side clearance 256. Test radiation emitted by the radiation source 236 therefore also radiates through clearances 254 and 256.

Since the clearance 252 and the radiation source 238 in the illustrated example are arranged coaxially with respect to flap swivel axis K, the fundamental capacity of the clearance 252 to allow test radiation from radiation source 238 to pass through does not change as a function of the swivel position of the air flap 218.

In order for the radiative detection device 234 nevertheless to be able to detect the rotational position of air flap 218, air flap 218 has in its test section 241, preferably at its one axial longitudinal end situated closer to the radiation receiver 238, that is, in the upper bearing journal 222, a polarization filter 258 that is swivable jointly with air flap 218. Additionally, an identical polarization filter 260 is accommodated fixed on the frame in the upper frame-side clearance 254, so that when air flap 218 is swiveled about flap swivel axis K, the polarization filter 258 fixed on the flap is swiveled relative to the polarization filter 260 fixed on the frame. The polarization filters 258 and 260 are here arranged in such a way that their polarization planes are parallel in the closed position of the air flap 218, so that light polarized by polarization filter 258 is also able to radiate through the polarization filter 260, while in the open position the polarization planes of the polarization filters 258 and 160 run crosswise, in particular orthogonally, to each other, so that in the open position not light or only very little light from the radiation source 136 reaches the radiation receiver 238.

Instead of polarization filters 258 and 260, diffraction gratings, radiation-refracting prisms and the like may be provided, which produce a change of the irradiation result on the radiation receiver 238 as a function of the swivel position of the air flap 218. For the detection of more complex irradiation results, such as predetermined diffraction patterns, the radiation receiver 238 may be a CCD field or a similar planar optical sensor, although this increases its costs.

Since all of the air flaps provided with reference numerals 18 through 218 in the present FIGS. 1 to 4 are assessable in their functionality by the detection device 34 to 234, all such air flaps in the FIGS. 1 to 4 are test air flap in the sense of the introduction of the description.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention.

Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-14. (canceled)

15. An air flap device for a motor vehicle, comprising a frame having an air passage opening, a plurality of air flaps accommodated on the frame in a jointly adjustable manner, which protrude at least into the air passage opening, and an actuator for adjusting the plurality of air flaps between two operating positions of different coverage of the air passage opening by the plurality of air flaps, the air flaps being jointly adjustable between a closed position, in which the air flaps cover the air passage opening to a greater degree against a flow through the passage, and an open position, in which the air flaps cover the air passage opening to a lesser degree against a flow through the passage, the air flap device further including a radiative detection device for detecting and assessing a position of the plurality of air flaps,
wherein the radiative detection device comprises a radiation source and a radiation receiver, the radiation source emitting an electromagnetic test radiation in the direction of the radiation receiver, at least one air flap from the plurality of air flaps as a test air flap having a test section through which the test radiation is able to pass, the test section being situated in the propagation path of the test radiation from the radiation source to the radiation receiver in such a way that when the test air flap is in a predetermined reference operating position, at least one portion of the test radiation radiates through the test section toward the radiation receiver and reaches the radiation receiver with an irradiation result within a predetermined irradiation result space, and when the test air flap is not in the predetermined reference operating position, the test radiation does not reach the radiation receiver with an irradiation result within the predetermined irradiation result space.

16. The air flap device as recited in claim 15, wherein the plurality of air flaps comprises multiple test air flaps, each of which includes one test section.

17. The air flap device as recited in claim 16, wherein the multiple test air flaps with their test sections are arranged in series, so that at least a portion of test radiation reaches the radiation receiver with an irradiation result within in a predetermined irradiation result space only when all test air flaps of the plurality of air flaps are in their respective reference operating position, and the test radiation does not reach the radiation receiver with an irradiation result within a predetermined irradiation result space when at least one of the multiple test air flaps is not in its reference operating position.

18. The air flap device as recited in claim 15, wherein the test air flap has a planar flap section, which is situated in the area of the air passage opening for changing the ability of air to flow through it, and a bearing section, which is designed in cooperation with a mating bearing section on the frame for the adjustable support of the test air flap on the frame.

19. The air flap device as recited in claim 18, wherein the test section is developed in the bearing section.

20. The air flap device as recited in claim 19, wherein the test air flap is situated on the frame so as to be swivable about a flap swivel axis, the test radiation being able to radiate through the test section in at least one of the following directions: crosswise to the flap swivel axis or along the flap swivel axis.

21. The air flap device as recited in claim 18, wherein the test air flap is situated on the frame so as to be swivable about a flap swivel axis, the test radiation being able to radiate through the test section in at least one of the following directions: crosswise to the flap swivel axis or along the flap swivel axis.

22. The air flap device as recited in claim 15, wherein the radiation source and the radiation receiver are situated on one and the same side of the air passage opening.

23. The air flap device as recited in claim 15, wherein the test section comprises or is a clearance.

24. The air flap device as recited in claim 15, wherein the test section comprises an optical radiation conductor having an entry area and an exit area, the optical radiation conductor conducting the electromagnetic test radiation from an entry area to an exit area of the optical radiation conductor.

25. The air flap device as recited in claim 15, wherein the radiative detection device comprises an optical radiation conductor that is fixed on the frame, which conducts the test radiation at least along a section of the path from the radiation source to the radiation receiver.

26. The air flap device as recited in claim 15, wherein the radiation source and the radiation receiver are located on the same side of the at least one test section and the radiative detection device comprises a radiation reversal device, which deflects the test radiation reaching it by 170° to 190°.

27. The air flap device as recited in claim 15, wherein the test radiation is able to radiate through the test air flap along the flap swivel axis, the radiative detection device comprising at least one beam-refracting and/or beam-diffracting and/or beam-polarizing and/or beam-interfering device.

28. The air flap device as recited in claim 15, wherein the radiation receiver is designed to differentiate irradiation results of at least one of the irradiation properties of irradiation intensity, irradiation wavelength, irradiation location and irradiation pattern of the test radiation irradiating the radiation receiver.

29. A vehicle having an air flap device as recited in claim 15, wherein a control device of the vehicle is designed for signal transmission with the detection device of the air flap device and for evaluating signals transmitted by the detection device.
